(19) United States
(12) Patent Application Publication
(10) Pub. No.: US 2024/0169415 A1
(43) Pub. Date: May 23, 2024

(54) COMMODITY PURCHASING SYSTEM AND COMMODITY PURCHASING METHOD

(71) Applicant: NEC Platforms, Ltd., Kawasaki-shi (JP)

(72) Inventor: Keisuke KATSURA, Kanagawa (JP)

(73) Assignee: NEC Platforms, Ltd., Kawasaki-shi (JP)

(21) Appl. No.: 18/386,289

(22) Filed: Nov. 2, 2023

(30) Foreign Application Priority Data
Nov. 17, 2022 (JP) 2022-184024

(51) Int. Cl. G06Q 30/0601; G06Q 20/20

(52) U.S. Cl. CPC G06Q 30/0633; G06Q 20/208

(57) ABSTRACT

A customer makes a reader unit of a commodity registration machine read a commodity code of the commodity, so that the commodity registration machine notifies the customer of completion, and, as the customer frames out the commodity code from a reading area of the reader unit within a predetermined period, a display unit of the commodity registration machine displays the commodity on a list as a purchase determined commodity. The customer makes the reader unit of the commodity registration machine read a commodity code of the commodity, so that the commodity registration machine notifies the customer of completion, and as the customer keeps the commodity in the commodity code reading state in the reading area of the reader unit, the commodity registration machine notifies the customer of completion and the display unit of the commodity registration machine displays the commodity on the list as a purchase deferred commodity.

### INCORPORATION BY REFERENCE

This application is based upon and claims the benefit of priority from Japanese patent application No. 2022-184024, filed on Nov. 17, 2022, the disclosure of which is incorporated herein in its entirety by reference.

### TECHNICAL FIELD

The present disclosure relates to a commodity purchasing system and a commodity purchasing method.

### BACKGROUND ART

A commodity purchasing system in which a customer purchases (i.e., selects) commodities and the like while moving a shopping cart or the like in a store, checks out the commodities and the like by himself/herself, and leaves the store has been developed.

Japanese Unexamined Patent Application Publication No. 2012-185550 discloses deferring setting means in which a user can set his/her intention of deferring the purchase of a certain commodity among commodities included in a commodity-to-be-purchased list which is set in advance.

In such a system, a customer may continue to consider whether or not to purchase a commodity until he/she has completed the check-out of (i.e., payment for) the commodity. In this case, when the customer wants to register the commodity as, for example, a purchase deferred commodity different from a purchase determined commodity, he/she has to perform an additional operation such as pressing a “deferring” button provided in a commodity registration machine such as a cart or reading a “deferring” code different from the commodity code by using a reader unit of the commodity registration machine.

### SUMMARY

The present disclosure has been made in order to solve the above-described problem, and an object thereof is to provide a commodity purchasing system and a commodity purchasing method capable of enabling a user to easily determine the purchase of a commodity or easily defer the purchase of a commodity.

A commodity purchasing system according to an aspect of the present disclosure is configured to:
when a customer wants to purchase a commodity, the customer makes a reader unit of a commodity registration machine read a commodity code of the commodity, so that the commodity registration machine notifies the customer of completion of the reading, and then, as the customer frames out the commodity code from a reading area of the reader unit within a predetermined period, a display unit of the commodity registration machine displays the commodity on a list as a purchase determined commodity; and
when the customer wants to defer purchase of a commodity, the customer makes the reader unit of the commodity registration machine read a commodity code of the commodity, so that the commodity registration machine notifies the customer of completion of the reading, and as the customer keeps the commodity in the commodity code reading state in the reading area of the reader unit for a predetermined period, the commodity registration machine notifies the customer of completion of the reading and the display unit of the commodity registration machine displays the commodity on the list as a purchase deferred commodity.

A commodity purchasing method according to an aspect of the present disclosure includes:
making, when a customer wants to purchase a commodity, a reader unit of a commodity registration machine read a commodity code of the commodity, so that the commodity registration machine notifies the customer of completion of the reading, and then, as the commodity code is framed out from a reading area of the reader unit within a predetermined period, displaying the commodity on a list as a purchase determined commodity; and
making, when the customer wants to defer purchase of a commodity, the reader unit of the commodity registration machine read a commodity code of the commodity, so that the commodity registration machine notifies the customer of completion of the reading, and as the commodity is kept in the commodity code reading state in the reading area of the reader unit for a predetermined period, the commodity registration machine notifies the customer of the completion of the reading and displays the commodity on the list as a purchase deferred commodity.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a diagram for explaining a commodity purchasing system according to some example embodiments;

FIG. 2 is a diagram for explaining a configuration of a cart according to some example embodiments;

FIG. 3 is a diagram for explaining a purchase commodity list displayed on a screen of a display unit of a commodity registration machine according to some example embodiments;

FIG. 4 is a diagram for explaining a status of a commodity according to some example embodiments;

FIG. 5 is a flowchart showing a commodity purchase method according to some example embodiments;

FIG. 6 is a table for explaining a relationship between statuses of commodities and warning messages according to some example embodiments;

FIG. 7 is a diagram for explaining an example of a warning message according to some example embodiments;

FIG. 8 is a diagram for explaining an example of a warning message according to some example embodiments; and

FIG. 9 is a diagram for explaining an example of a warning message according to some example embodiments.

### EXAMPLE EMBODIMENT

Specific example embodiments to which the present disclosure is applied will be described in detail with reference to the drawings. However, the present disclosure is not limited to the following example embodiments. Further, for clarifying the explanation, the following descriptions and drawings are simplified as appropriate.

### First Example Embodiment

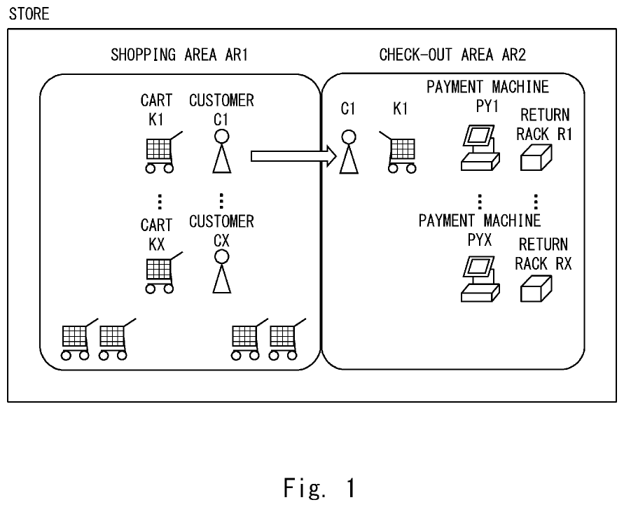

An example embodiment will be described hereinafter with reference to FIGS. 1 to 3.

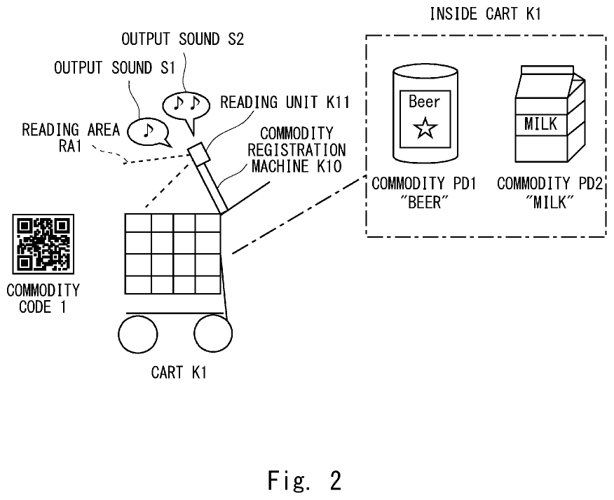

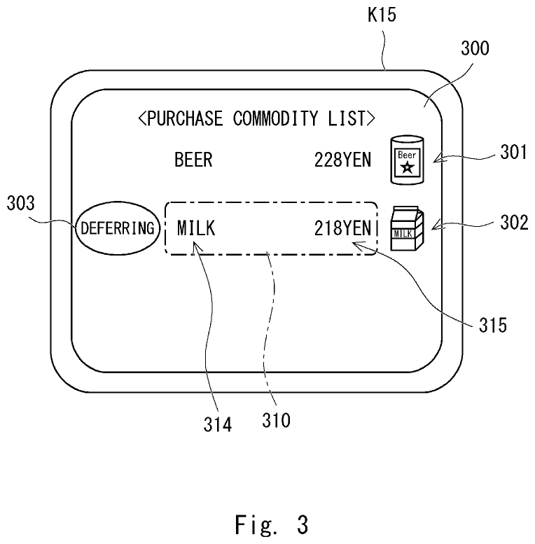

FIG. 1 is a diagram for explaining an overall configuration of a commodity purchasing system according to this example embodiment. FIG. 2 is a diagram for explaining an example of a cart on which a commodity registration machine can be mounted. FIG. 3 shows an example of a display unit of the commodity registration machine.

This commodity purchasing system provides, for example, a mechanism by which a customer C1 using a shopping cart or the like (K1 in FIG. 1) who purchases (i.e., selects) commodities and the like in a store can also register a commodity which the customer C1 is considering whether or not to purchase (also called a purchase deferred commodity).

When the customer C1 wants to purchase a commodity (e.g., a can of beer), he/she makes a reader unit K11 of a commodity registration machine K10 read the commodity code of the commodity, so that the commodity registration machine K10 notifies the customer C1 of the completion of the reading. After that, the customer C1 frames out (i.e., moves out) the commodity code from a reading area RA1 of the reader unit K11 within a predetermined period, so that a display unit K15 of the commodity registration machine K10 displays the commodity (e.g., beer) on a list as a purchase determined commodity.

On the other hand, when the customer C1 wants to defer the purchase of a commodity (e.g., a carton of milk), the commodity registration machine K10 makes the reader unit K11 of the commodity registration machine K10 read the commodity code of the commodity, so that the commodity registration machine K10 notifies the customer of the completion of the reading. Further, as the customer C1 keeps the commodity in the commodity code reading state in the reading area RA1 of the reader unit K11 for a predetermined period, the commodity registration machine K10 notifies the customer of the completion of the reading and the display unit K15 of the commodity registration machine K10 displays the commodity (e.g., milk) on the list as a purchase deferred commodity.

The above-described method for notifying the customer of the completion of the reading may be, for example, a voice notification or a message displayed on the display unit. When the customer defers the purchase, he/she is notified of the completion of the first reading and the completion of the second reading, and the methods for these notifications may be the same as each other or different from each other.

Further, the above-described commodity registration machine may be mounted on a shopping cart or installed in a mobile terminal. The commodity registration machine may be a computer including a display unit, a speaker, a processor, a memory, and the like. The mobile terminal may be any of various devices that the customer can carry with him/her when he/she moves, such as a smartphone, a wearable apparatus, and a smartwatch. In the case of the mobile terminal, the function of the commodity registration machine may be in the form of application software or the like, and is installed and used in the mobile terminal. Further, in this case, commodity registration data (which will be described later) may be stored in a storage unit of the mobile terminal, or may be wirelessly transmitted from the mobile terminal to a management server and stored in the management server.

In other words, the present disclosure provides means for distinguishing, when a customer registers a commodity as a purchase deferred commodity and puts it in a cart, this commodity from other commodities during the process for reading the commodity code of the purchase deferred commodity itself. Specifically, when the commodity code is scanned, a scan completion sound 1 is output upon the completion of the scanning, and as the commodity code is continuously read for a certain time (i.e., as the commodity is kept unmoved), so that it is recognized that the commodity should be registered as a “purchase deferred” commodity and an additional scan completion sound 2 is output. Note that in this example, the scan completion sounds 1 and 2 are typically different from each other.

Further, in some example embodiments, when the customer carries out a payment process (i.e., check-out) for the purchase deferred commodity, if there is a commodity of which the customer has not changed its status to a purchase determined commodity and hence which remains in the status as the purchase deferred commodity or a purchase cancelled commodity, it is possible to output a warning message for urging the customer not to unintentionally or intentionally take out the unpaid commodity.

In this commodity purchasing system, after a customer enters a store such as a supermarket, he/she scans (registers) commodities he/she wants to purchase by using the commodity registration machine and put the commodities in a cart in a shopping area. After that, after the customer selects all commodities he/she wants to purchase, he/she can check out the commodities by himself/herself in a check-out area without being intervened by a store clerk, and leave the store. The present disclosure relates, in particular, to a technology or the like for enabling a customer or the like to easily determine the purchase of commodities and easily defer the purchase of commodities in a shopping area.

### Second Example Embodiment

As shown in FIG. 1, in a commodity purchasing system according to this example embodiment, a store includes a shopping area AR1 and a check-out area AR2.

When a customer C1 starts shopping in the store, the customer C1 moves with a shopping cart K1 (hereinafter also referred to simply as a cart K1) provided in the shopping area AR1. After the customer C1 registers commodities he/she wants to purchase and puts them in the cart K1 in the shopping area AR1, in order to check out the commodities, the customer C1 moves with the cart K1 to the check-out area AR2 and check out the commodities by himself/herself by using a payment machine PY1 installed in the check-out area AR2. When the customer C1 decides not to purchase a commodity (e.g., one of the commodities put in the cart) in the check-out area AR2, he/she returns that commodity to a return rack R1.

As shown in FIG. 1, a large number of carts K, which may be determined according to the number of expected customers, are provided. Further, a large number of payment machines PY and a larger number of return racks R, which may be determined according to the number of carts K, are provided.

FIG. 2 is a diagram for explaining a configuration of a cart.

The cart K1 is equipped with a commodity registration machine K10, and the commodity registration machine K10 is equipped with a reader unit K11. The reader unit can be any of various sensors such as a camera that can read a commodity code. By starting up the reader unit, for example, “Please read a commodity code”, and “You can register a commodity as a purchase deferred commodity by keeping it in the reading state for two seconds or longer. When it beeps, the registration is completed.” can be displayed on a display unit.

The reader unit K11 can read a commodity code (e.g., any of various identification codes such as a bar code and a QR code (Registered Trademark)) of a commodity positioned inside the reading area RA1. Further, upon the completion of the reading, the reader unit K11 (or the commodity registration machine K10) outputs an output sound S1 through a speaker, and after that, when the commodity is kept unmoved and the commodity code reading state is continued for a predetermined time (e.g., two seconds or more), outputs an output sound S2. The output sounds S1 and S2 may be sounds different from each other (e.g., different beeping sounds such as a single beeping sound and consecutive double bleeping sounds), or may be voice messages different from each other (e.g., “Reading has been completed” and “It has been registered as a purchase deferred commodity”, respectively). In FIG. 2, as an example, a commodity PD1 “beer” and a commodity PD2 “milk” are contained in the cart K1. Further, similarly to the cart K1, each of many or all carts K in the store may include a commodity registration machine, a reader unit, a speaker, and the like.

FIG. 3 is a diagram for explaining a list of commodities to be purchased (hereinafter also referred to as a purchase commodity list) displayed on a screen of the display unit of the commodity registration machine.

When the customer C1 registers a commodity as a commodity to be purchased by using the reader unit K11 in the shopping area AR1, the commodity may be registered as an “A. Purchase determined” commodity, i.e., a commodity which the customer C1 has already decided to purchase, or as a “B. Purchase deferring” commodity, i.e., a commodity which the customer C1 has not yet decided to purchase. Therefore, the commodity registration machine K10 provided in the cart K1 shown in FIG. 2 can perform control and displaying so that “A. Purchase determined” commodities and “B. Purchase deferring” commodities are distinguished from each other.

For example, in FIG. 3, on a screen 300 on which a purchase commodity list of the commodity registration machine K10 is displayed, in an item 301, a commodity name “beer”, price information “228 yen”, and its commodity image are displayed as a purchase determined commodity. Meanwhile, in an item 302, a commodity name “milk”, price information “218 yen”, and its commodity image are displayed as a purchase deferred commodity. For the milk, which is a purchase deferred commodity, a deferring icon 303 is also displayed. Further, in order to distinguish the purchase deferred commodity from the other purchase determined commodity, for example, the whole line area 310 including the commodity name “milk” and the price information “218 yen” may be overlaid with a predetermined color (e.g., red), and letters 314 and 315 may be displayed as outline letters. Note that purchase deferred commodities may be displayed in the form of a list on the screen 300 of the display unit K15 by various methods so that they can be distinguished from purchase determined commodities.

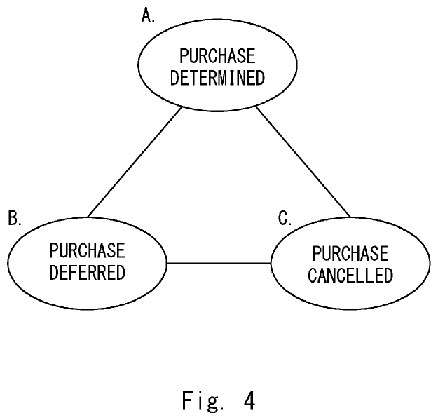

FIG. 4 is a diagram for explaining transitions of statuses of a commodity in this commodity purchasing system.

When the customer has decided not to purchase a commodity, he/she can change the status of the commodity to a “C. Purchase cancelled” commodity by performing an operation or the like on the commodity registration machine. In this way, when the customer, who is putting various commodities in the cart, finds a commodity that he/she prefer to purchase rather than purchasing a commodity that he/she selected (i.e., put in the cart) earlier, he/she can also change the status of the earlier-selected commodity to a purchase-cancelled commodity. Further, the customer can change the status of a commodity to any of the “B. Purchase deferring” commodity, the “A. Purchase determined” commodity, and the “C. Purchase cancelled” commodity from one to another by performing a touch operation on the screen of the commodity registration machine (e.g., in the shopping area) provided that the commodity has not been checked out yet.

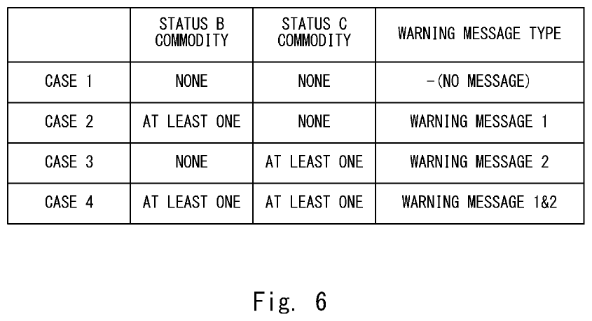

FIG. 6 is a table for explaining a relationship between statuses of commodities and warning messages.

In this commodity purchasing system, it is possible to output various warning messages according to the status of a commodity. For example, when the customer C1 pays for commodities by using the payment machine PY1 in the check-out area AR2, and there is a commodity whose status is still a “B. Purchase deferring” commodity or a “C. Purchase cancelled” commodity, both of which are commodities that will not be checked out, the commodity registration machine K10 can output the below-described “warning messages”. An example of the warning message is one by which it is possible to urge the customer to change the status of the commodity to an “A. Purchase determined” commodity in order to prevent the customer from leaving with the cart in which the commodity that has not been checked out is left unremoved. Further, another example of the warning message is one by which it is possible to urge the customer to take out the commodity itself of which the status has been changed to a “C. Purchase cancelled” commodity from the cart and return the commodity to a return rack or the like. The above-described examples of warning messages are merely examples, and various variations are conceivable.

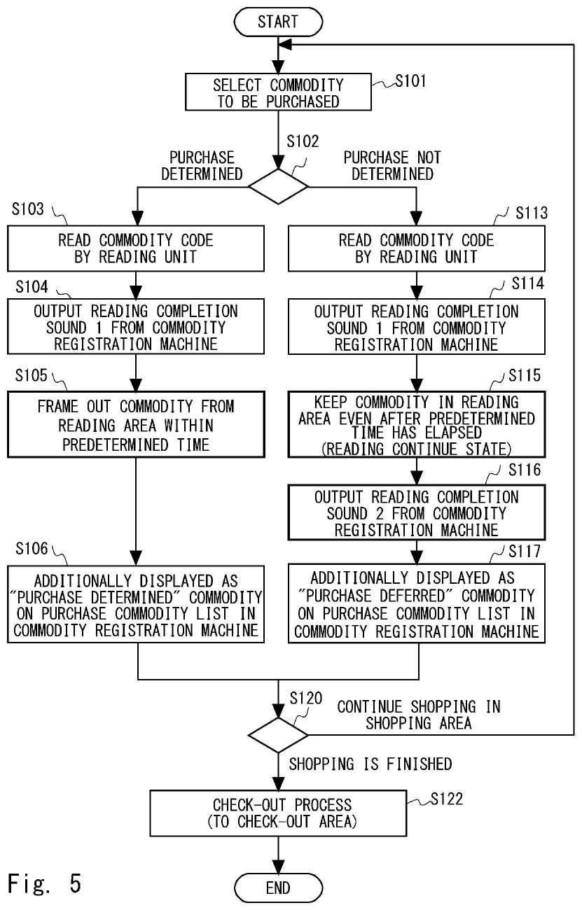

A case where the customer C1 registers a commodity PD1 which he/she has decided to purchase in the shopping area AR1 by using the commodity registration machine K10 and put it in the cart K1, and a case where the customer C1 registers a commodity PD2 which he/she has not yet decided to purchase by using the commodity registration machine K10 and put it in the cart K1 will be described with reference to a flowchart shown in FIG. 5.

As shown in FIG. 1, since the customer C1 starts shopping in the store in this commodity purchasing system, the customer C1 moves with the cart K1 provided in the shopping area AR1. The customer selects commodities he/she wants to purchase from a commodity shelf in the shopping area AR1 (Step S101).

For the commodity PD1, which the customer C1 has decided to purchase (the purchase was determined in the step S102), the customer C1 frames (i.e., moves) its commodity code into the reading area RA1 of the reader unit K11, so that the reader unit K11 starts reading the commodity code (Step S103). Upon the completion of the reading, the commodity registration machine K10 outputs an output sound S1 (Step S104). The customer C1 hears this output sound S1, frames out (i.e., moves out) the commodity code of the commodity from the reading area RA1, and then puts the commodity in the cart K1 (Step S105). The commodity registration machine K10 recognizes that the commodity PD1 is an “A. Purchase determined” commodity, and displays a commodity name, price information, and a commodity image (Beer and 228 Yen in FIG. 3) on the purchase commodity list of the display unit K15 (Step S106).

On the other hand, for the commodity PD2, which the customer C1 has not yet decided to purchase (the purchase has not yet decided in the step S102), when the customer C1 frames (moves) the commodity code of the commodity PD2 into the reading area RA1 of the reader unit K11, the reader unit K11 starts reading the commodity code (Step S113). Upon the completion of the reading, the commodity registration machine K10 outputs an output sound S1 (Step S114). Although the processes up to this point are the same as those for the commodity PD1, the customer C1 does not frame out (i.e., does not move out) the commodity code of commodity PD2 from the reading area RA1 and keeps the commodity PD2 unmoved even after he/she hears the output sound S1 (Step S115). Since the commodity registration machine K10 remains in the reading state of the commodity code of the commodity PD2 and the commodity PD2 is not moved, the commodity registration machine K10 outputs an output sound S2 after a predetermined time has elapsed (Step S116). The customer C1 hears the output sound S2, frames out (i.e., moves out) the commodity code of the commodity PD2 from the reading area RA1, and then puts the commodity PD2 in the cart K1. The commodity registration machine K10 recognizes that the commodity PD2 is a “B. Purchase deferring” commodity, and displays an image or the like by which the customer C1 can clearly recognize that the commodity is the “B. Purchase deferring” commodity (e.g., a deferring icon, outline letters, and the like as shown in FIG. 3) together with a commodity name, price information, and a commodity image displayed on the display unit K15 (Step S117).

Note that when the customer C1 decides not to purchase a commodity that is already put in the cart K1, i.e., a commodity that is registered in the commodity registration machine K10, when he/she is selecting commodities in the shopping area AR1, the customer C1 can change the status of this commodity to a “C. Purchase cancelled” commodity in the commodity registration machine K10. As shown in FIG. 4, the customer C1 can change the status of a commodity to any of a “B. Purchase deferring” commodity, an “A. Purchase determined” commodity, and a “C. Purchase cancelled” commodity from one to another by performing an operation on the commodity registration machine K10 provided that the check-out of the commodity in the payment machine PY1 has not been carried out yet.

When the customer C1 continues the shopping in the shopping area (shopping is continued in the step S120), the process returns to the process in the step S101 and the above-described series of processes is repeated. On the other hand, when the customer C1 finishes the registration of commodities in the shopping area AR1 and checks out the commodities (shopping is finished in step S120), the customer C1 moves to the check-out area AR2 (Step S122).

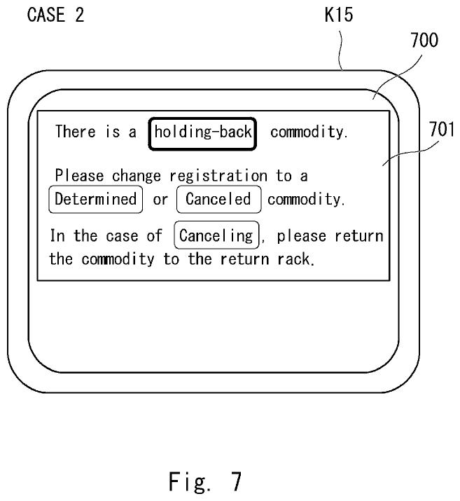

It should be noted that in general, before the customer C1 checks out the commodities in the payment machine PY1 in the check-out area AR2, he/she changes the status of a “B. Purchase deferring” commodity(ies) in the commodity registration machine K10 to an “A. Purchase determined” commodity or a “C. Purchase cancelled” commodity, and then checks out the commodities. However, when the customer C1 unintentionally or intentionally starts checking out a commodity of which the status is a “B. Purchase deferring” commodity, the commodity registration machine K10 and the payment machine PY1 can output a “warning message 1” in order to urge the customer C1 not to leave the store with the commodity of which the status is the “B. Purchase deferring” commodity, i.e., with the commodity that is not checked out, as shown in FIG. 7. For example, the first warning message 701 shown in FIG. 7 may contain a message “There is a deferring commodity. Please change the registration of the commodity to a “Determined” commodity or a “Canceled” commodity. In the case of “Canceling”, please return the commodity to the return rack”.

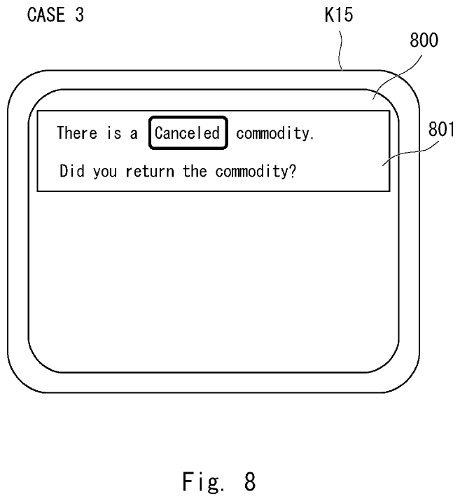

Further, for a “C. Purchase cancelled” commodity, a general flow is as follows, i.e., the customer C1 removes this commodity from the cart K1 in the check-out area AR2, returns it to the return rack R1, and then start checking out the remaining commodities in the payment machine PY1. However, when the customer C1 unintentionally or intentionally starts checking out a commodity of which the status remains as a “C. Purchase cancelled” commodity, the commodity registration machine K10 and the payment machine PY1 outputs a “warning message 2” in order to urge the customer C1 not to leave the store with the commodity that is not purchased, i.e., the commodity of which the status is a “C. Purchase cancelled” commodity, i.e., the commodity that is not checked out, as shown in FIG. 8. For example, the second warning message 801 shown in FIG. 8 may contain a message “There is a “Canceled” commodity. Did you return the commodity?”.

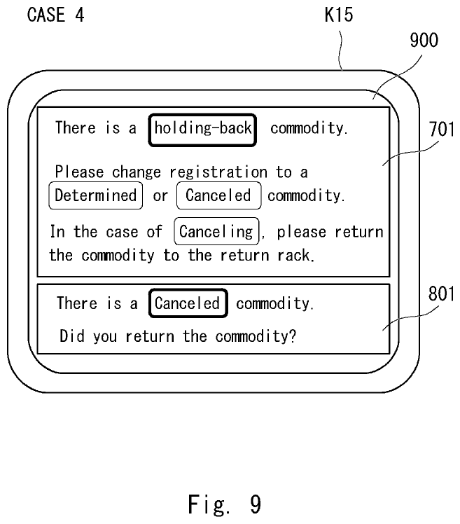

Further, in another example embodiment, when there is a “B. Purchase deferring” commodity and a “C. Purchase cancelled” commodity in the cart, the commodity registration machine K10 and the payment machine PY1 may output a warning message containing the above-described first and second warning messages 701 and 801 as shown in FIG. 9.

The above-described warning message makes it possible to output the commodity registration data of the commodity registration machine K10 to the payment machine PY1 and, for example, at least one of the commodity registration machine K10 and the payment machine PY1 at a coordinated (or synchronized) timing by, for example, wireless communication or the like in order to enable the customer C1 to move to the check-out area AR2 and check out the commodities in the payment machine PY1. As an example, the coordination and synchronization method may be implemented by displaying a QR code (Registered Trademark) on the display unit K15 of the commodity registration machine K10 and reading the displayed QR code (Registered Trademark) by using the reader unit of the payment machine PY1. Further, as another example, the coordination and synchronization of commodity registration data may be carried out when it is detected that the distance between the commodity registration machine K10 and the payment machine PY1 gets close to a certain range by using radio communication such as RFID, Bluetooth, or Wi-Fi. Whether or not a warning message should be output and the type of the warning message are determined depending on the presence/absence of a “B. Purchase deferring” commodity and/or a “C. Purchase cancelled” commodity in the commodity registration data. When there are only “A. Purchase determined” commodities, no warning message is output.

### <Effects>

As an operation that is performed when a customer wants to handle a commodity as a “purchase deferred” commodity, it is possible to carry out this operation just by changing the length of time during which a commodity code is read, i.e., to carry out this operation substantially without performing any additional operation. Note that the additional operation that has been necessary in the past may be, for example, before reading a commodity code, performing another operation such as pressing a “deferring” button displayed in the commodity registration machine or reading a “deferring” code different from the commodity code.

The store can output a “warning message” in order to urge a customer not to unintentionally or intentionally leave the store with a purchase deferred commodity or a purchase cancelled commodity, both of which are not checked out, i.e., not to leave the store without returning the purchase deferred commodity or the purchase cancelled commodity to the store.

### Other Example Embodiment

In addition to the operation of a self-cart and the commodity registration machine provided by the store, it is also possible to use any of various types of mobile terminals, such as smartphones, personally owned by customers as a device similar to the commodity registration machine by installing application software similar to that installed in the commodity registration machine of the store in the mobile terminal. The mobile terminal may be a general-purpose computer including a display unit, a speaker, an operation unit such as a touch input panel or buttons, a processor, a memory, and the like

In another example embodiment, the reader unit may output, after reading a commodity code, a reading completion sound, and then output an output sound indicating the completion of the registration of a purchase deferred commodity after a predetermined period has elapsed with the commodity code being not framed out (i.e., being not moved out) from the reading area. Then, when a predetermined period has further elapsed with the commodity code being not framed out (i.e., being not moved out) from the reading area, the reader unit (or the commodity registration machine) may determine that the customer is unintentionally continuing the reading and therefore output an error message. Further, in still another example embodiment, upon the completion of the first reading, the commodity may be registered as a deferring commodity, and upon the completion of the second reading, the commodity may be registered as a determined commodity.

The output sound that is output upon the completion of the reading of the commodity code, and the output sound that is output upon the completion of the reading of the deferring determination may be guidance voice messages such as “Reading has been completed” or “Registered as a deferring commodity”, respectively.

Further, as the procedure of processes performed in the commodity purchasing system have been described above in the above-described various example embodiments, the present disclosure may be implemented in the form of a commodity purchasing method. This commodity purchasing method includes the following steps. a step of making, when a customer wants to purchase a commodity, a reader unit of a commodity registration machine read a commodity code of the commodity, so that the commodity registration machine notifies the customer of completion of the reading, and then, as the commodity code is framed out from a reading area of the reader unit within a predetermined period, displaying the commodity on a list as a purchase determined commodity; and a step of making, when the customer wants to defer purchase of a commodity, the reader unit of the commodity registration machine read a commodity code of the commodity, so that the commodity registration machine notifies the customer of completion of the reading, and as the commodity is kept in the commodity code reading state in the reading area of the reader unit for a predetermined period, the commodity registration machine notifies the customer of the completion of the reading and displays the commodity on the list as a purchase deferred commodity. Note that other examples are as described above in the above-described various example embodiments.

Note that the present disclosure is not limited to the above-described example embodiments, and they may be modified as necessary without departing from the scope and spirit of the disclosure.

The whole or part of the example embodiments disclosed above can be described as, but not limited to, the following supplementary notes.

### (Supplementary Note 1)

A commodity purchasing system configured to:
when a customer wants to purchase a commodity, the customer makes a reader unit of a commodity registration machine read a commodity code of the commodity, so that the commodity registration machine notifies the customer of completion of the reading, and then, as the customer frames out the commodity code from a reading area of the reader unit within a predetermined period, a display unit of the commodity registration machine displays the commodity on a list as a purchase determined commodity; and
when the customer wants to defer purchase of a commodity, the customer makes the reader unit of the commodity registration machine read a commodity code of the commodity, so that the commodity registration machine notifies the customer of completion of the reading, and as the customer keeps the commodity in the commodity code reading state in the reading area of the reader unit for a predetermined period, the commodity registration machine notifies the customer of completion of the reading and the display unit of the commodity registration machine displays the commodity on the list as a purchase deferred commodity.

### (Supplementary Note 2)

The commodity purchasing system described in Supplementary note 1, wherein when the customer wants to defer purchase of a commodity, the customer makes the reader unit of the commodity registration machine read a commodity code of the commodity, so that the commodity registration machine notifies the customer by a first reading completion sound, and as the customer keeps the commodity in the commodity code reading state in the reading area of the reader unit for a predetermined period, the commodity registration machine notifies the customer by a second reading completion sound different from the first reading completion sound.

### (Supplementary Note 3)

The commodity purchasing system described in Supplementary note 1, wherein the purchase deferred commodity is listed on the list displayed on a screen of the display unit in such a manner that the purchase deferred commodity can be distinguished from the purchase determined commodity.

### (Supplementary Note 4)

The commodity purchasing system described in Supplementary note 1, wherein the system is configured such that the customer can change, before checking out a commodity, a status of the commodity to any of a purchase determined commodity, a purchase deferred commodity, and a purchase cancelled commodity from one to another by performing an operation on the commodity registration machine.

### (Supplementary Note 5)

The commodity purchasing system described in Supplementary note 4, wherein
a store includes a shopping area and a check-out area, and
the commodity purchasing system is further configured to, when the customer carries the purchase deferred commodity in the check-out area, output a first warning message in order to urge the customer to change the status of the commodity to a purchase determined commodity or not to leave the store with the commodity that is not purchased.

### (Supplementary Note 6)

The commodity purchasing system described in Supplementary note 4, wherein
a store includes a shopping area and a check-out area, and
the commodity purchasing system is further configured to, when the customer carries the purchase cancelled commodity in the check-out area, output a second warning message in order to urge the customer to return the purchase cancelled commodity.

### (Supplementary Note 7)

The commodity purchasing system described in Supplementary note 5 or 6, wherein when the customer carries the purchase deferred commodity and the purchase cancelled commodity in the check-out area, the commodity registration machine or a payment machine outputs a first warning message in order to urge the customer to change a status of the commodity to a purchase determined commodity or not to leave the store with the commodity that is not purchased and also outputs a second warning message different from the first warning message in order to urge the customer to return the purchase cancelled commodity.

### (Supplementary Note 8)

The commodity purchasing system described in Supplementary note 7, wherein the first and second warning messages make it possible to output commodity registration data of the commodity registration machine at a timing that is coordinated with the payment machine.

### (Supplementary Note 9)

The commodity purchasing system described in Supplementary note 1, wherein the commodity registration machine is mounted on a shopping cart or installed in a mobile terminal.

### (Supplementary Note 10)

The commodity purchasing system described in Supplementary note 1, wherein when the customer wants to defer purchase of a commodity, the customer makes the reader unit of the commodity registration machine read a commodity code of the commodity, so that the commodity registration machine notifies the customer of completion of the reading; as the customer keeps the commodity in the commodity code reading state in the reading area of the reader unit for a predetermined period, the commodity registration machine notifies the customer of completion of the reading, and the display unit of the commodity registration machine displays the commodity on the list as a purchase deferred commodity; and when the commodity code reading state continues further for a predetermined time or longer, the commodity registration machine notifies the customer of an error.

### (Supplementary Note 11)

A commodity purchasing method comprising:
making, when a customer wants to purchase a commodity, a reader unit of a commodity registration machine read a commodity code of the commodity, so that the commodity registration machine notifies the customer of completion of the reading, and then, as the commodity code is framed out from a reading area of the reader unit within a predetermined period, displaying the commodity on a list as a purchase determined commodity; and
making, when the customer wants to defer purchase of a commodity, the reader unit of the commodity registration machine read a commodity code of the commodity, so that the commodity registration machine notifies the customer of completion of the reading, and as the commodity is kept in the commodity code reading state in the reading area of the reader unit for a predetermined period, the commodity registration machine notifies the customer of the completion of the reading and displays the commodity on the list as a purchase deferred commodity.

According to the present disclosure, it is possible to provide a commodity purchasing system and a commodity purchasing method capable of enabling a user to easily determine the purchase of a commodity or easily defer the purchase of a commodity. A program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives and the like), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory) and the like). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

The first and second example embodiments can be combined as desirable by one of ordinary skill in the art.

While the disclosure has been particularly shown and described with reference to example embodiments thereof, the disclosure is not limited to these example embodiments. It will be understood by those of ordinary skill in the art that various changes in form and details may be made therein without departing from the spirit and scope of the present disclosure as defined by the claims.

What is claimed is:

1. A commodity purchasing system configured to:
when a customer wants to purchase a commodity, the customer makes a reader unit of a commodity registration machine read a commodity code of the commodity, so that the commodity registration machine notifies the customer of completion of the reading, and then, as the customer frames out the commodity code from a reading area of the reader unit within a predetermined period, a display unit of the commodity registration machine displays the commodity on a list as a purchase determined commodity; and
when the customer wants to defer purchase of a commodity, the customer makes the reader unit of the commodity registration machine read a commodity code of the commodity, so that the commodity registration machine notifies the customer of completion of the reading, and as the customer keeps the commodity in the commodity code reading state in the reading area of the reader unit for a predetermined period, the commodity registration machine notifies the customer of completion of the reading and the display unit of the commodity registration machine displays the commodity on the list as a purchase deferred commodity.

2. The commodity purchasing system according to claim 1, wherein when the customer wants to defer purchase of a commodity, the customer makes the reader unit of the commodity registration machine read a commodity code of the commodity, so that the commodity registration machine notifies the customer by a first reading completion sound, and as the customer keeps the commodity in the commodity code reading state in the reading area of the reader unit for a predetermined period, the commodity registration machine notifies the customer by a second reading completion sound different from the first reading completion sound.

3. The commodity purchasing system according to claim 1, wherein the purchase deferred commodity is listed on the list displayed on a screen of the display unit in such a manner that the purchase deferred commodity can be distinguished from the purchase determined commodity.

4. The commodity purchasing system according to claim 1, wherein the system is configured such that the customer can change, before checking out a commodity, a status of the commodity to any of a purchase determined commodity, a purchase deferred commodity, and a purchase cancelled commodity from one to another by performing an operation on the commodity registration machine.

5. The commodity purchasing system according to claim 4, wherein
a store includes a shopping area and a check-out area, and
the commodity purchasing system is further configured to, when the customer carries the purchase deferred commodity in the check-out area, output a first warning message in order to urge the customer to change the status of the commodity to a purchase determined commodity or not to leave the store with the commodity that is not purchased.

6. The commodity purchasing system according to claim 4, wherein
a store includes a shopping area and a check-out area, and
the commodity purchasing system is further configured to, when the customer carries the purchase cancelled commodity in the check-out area, output a second warning message in order to urge the customer to return the purchase cancelled commodity.

7. The commodity purchasing system according to claim 5, wherein when the customer carries the purchase deferred commodity and the purchase cancelled commodity in the check-out area, the commodity registration machine or a payment machine outputs a first warning message in order to urge the customer to change a status of the commodity to a purchase determined commodity or not to leave the store with the commodity that is not purchased and also outputs a second warning message different from the first warning message in order to urge the customer to return the purchase cancelled commodity.

8. The commodity purchasing system according to claim 7, wherein the first and second warning messages make it possible to output commodity registration data of the commodity registration machine at a timing that is coordinated with the payment machine.

9. The commodity purchasing system according to claim 1, wherein the commodity registration machine is mounted on a shopping cart or installed in a mobile terminal.

10. A commodity purchasing method comprising:
making, when a customer wants to purchase a commodity, a reader unit of a commodity registration machine read a commodity code of the commodity, so that the commodity registration machine notifies the customer of completion of the reading, and then, as the commodity code is framed out from a reading area of the reader unit within a predetermined period, displaying the commodity on a list as a purchase determined commodity; and
making, when the customer wants to defer purchase of a commodity, the reader unit of the commodity registration machine read a commodity code of the commodity, so that the commodity registration machine notifies the customer of completion of the reading, and as the commodity is kept in the commodity code reading state in the reading area of the reader unit for a predetermined period, the commodity registration machine notifies the customer of the completion of the reading and displays the commodity on the list as a purchase deferred commodity.
